(19) United States
(12) Patent Application Publication
(10) Pub. No.: US 2005/0008886 A1
(43) Pub. Date: Jan. 13, 2005

(54) Method for producing polymer semi-products with high and ultra-high molecular weight, resulting semi-products and uses thereof

(76) Inventors: Hubert Rosing, Vreden (DE); Franz-Josef Focking, Sudlohn (DE); Werner Wohrmann, Vreden (DE)

Correspondence Address: BARNES & THORNBURG, 11 SOUTH MERIDIAN, INDIANAPOLIS, IN, 46204, US

(21) Appl. No.: 10/492,076

(22) PCT Filed: Oct. 2, 2002
(86) PCT No.: PCT/EP02/11074

(30) Foreign Application Priority Data
Oct. 10, 2001 (DE) 101 49 884.5

(51) Int. Cl. B32B 27/32

(52) U.S. Cl. 428/523

(57) ABSTRACT

The invention concerns a method for producing semi-products as well as molded parts and finished products made of high and ultra-high molecular weight, in particular of polyethylene having a mean mole weight higher than 500,000 g/mole, using a sintering process. The polymer, comprised in a support containing an oxygen-free atmosphere, is compressed to produce a molded part or a semi-product and is then separated from the support. The invention also concerns the resulting semi-products. Increased density and low free radical content enable enhanced aging resistance and wear resistance of the semi-products and molded parts.

The invention relates to a method for producing semi-products, as well as moulded and finished products made of high and ultra-high molecular weight polymers, in particular polyethylene with a mean molar mass of more than 500,000 g/mol and also semi-products produced in this manner. Because of the increased density and the reduced radical content, improvements in ageing resistance and in abrasion resistance result for semi-products and moulded products.

The production of semi-products made of high and ultra-high molecular weight polymers by compression and sintering of pulverulent polymeric starting material is known from the state of the art. Because of the high molecular weight of the polymers, a sintering process results which makes the subsequent shaping possible. Because of atmospheric conditions, thermal damage to the polymer can occur during this process, by means of which the ageing resistance and the abrasion resistance is reduced. One possibility of avoiding this problem is the production of semi-products of this type in an oxygen-free atmosphere also under clean-room conditions.

Starting from these disadvantages of the state of the art, it is therefore the object of the present invention to provide a method for producing semi-products made of high and ultra-high molecular weight polymers, in which contact with oxygen during the sintering process can be avoided in a simple and economical manner also under clean-room conditions. Within the scope of this application, there should be understood by the term semi-products also moulded and finished products.

This object is achieved by the generic method having the characterising features of claim 1 and by the semi-product produced in this manner having the features of claim 12. The further dependent claims reveal advantageous developments of the invention. The use of the semi-products is described in claims 15 to 17.

According to the invention, a method for producing semi-products made of high and ultra-high molecular weight polymers, in particular polyethylene with a mean molar mass of more than 500,000 g/mol, is provided. This is based on a sintering process which is implemented at temperatures between 150 and 300° C. and at pressures between 50 and 400 bar.

This sintering process, which is known from the state of the art, is modified according to the invention in such a manner that the polymer is included in a container containing an oxygen-free atmosphere. After the compression into a semi-product, which can be effected for example by plate compression, then the container is subsequently separated from the semi-product.

As a result, it is now made possible that contact between polymer and oxygen from the surrounding atmosphere is prevented during the sintering process. Surprisingly, it was able to be shown that polymers produced in this manner have a smaller concentration of free radicals and consequently have high ageing resistance and abrasion resistance.

Preferably, the container is formed from a polymer film with good barrier properties against oxygen so that the intake of oxygen is prevented during the process by the polymer film. It is thereby preferred that the container is formed from a polymer with temperature stability up to 300° C. in order to prevent thermal decomposition of the container during the sintering process.

The polymer is filled into the container at the beginning, preferably in powder or granulate form. Subsequently the inclusion of the polymer in the container is effected preferably by adhesion and/or welding of the container. Hereafter there follows the production of in oxygen-free atmosphere in the container, for which preferably the evacuation of the container and/or the flushing with an inert gas, e.g. nitrogen or a noble gas, is implemented.

Likewise it is however also possible that production of the oxygen-free atmosphere is effected before inclusion of the polymer, i.e. before adhesion or welding.

In an advantageous embodiment of the method, the container is embedded in additional polymer in such a manner that damage to the container during the compression process is prevented. Because of the temperature and pressure conditions of the sintering process, damage to the container cannot be excluded. By embedding the container in further polymer material, as a result of which evening-out of the pressure conditions on the container surface is achieved, damage of this type can be avoided in a more simple manner.

Preferably, there is used as polymer ultra-high molecular weight polyethylene (UHMW-PE) with a mean molar mass of more than 500,000 g/mol.

The sintering process is thereby implemented in an advantageous development of the method at a temperature between 150 and 250° C. and at a pressure between 80 and 150 bar.

According to the invention, a semi-product made of ultra-high, molecular weight polymer is likewise provided, which can be produced according to the method according to the invention. This semi-product has a density between 0.940 and 0.970 cm³/g. Preferably, the density of the semi-product is between 0.945 and 0.960 cm³/g. Surprisingly, these semi-products have no thermally conditioned polymeric defective structures at this, relative to the state of the art, higher density.

According to the invention, the semi-products have a very low concentration of free radicals which can be established by means of electron spin resonance spectra. Thus the signal amplitude of an electron spin resonance spectrum of the semi-product, in comparison to untreated material, is less than 50%. This leads to a significantly improved light and ageing resistance and also to increased abrasion resistance which are verified by means of tests for abrasion resistance.

Preferably, the polymer is produced in pure form, i.e. without further additives.

Because of the improved properties with respect to ageing resistance and abrasion resistance, the semi-product according to the invention is suitable for producing bio-inert medical appliances or implants.

It is likewise possible to produce the material not in sheet form, as known from the state of the art, but also to implement the production of preforms. These can in turn then be further processed subsequently with low mechanical complexity into the corresponding appliances or implants.

The use of semi-products, moulded or finished products can also be used for general technical purposes if increased ageing resistance and/or lower abrasion is required.

1. A method for producing at least one of semi-products, molded products and finished products made of at least one of high molecular weight polymers and ultra-high molecular weight polymers by means of a sintering process, wherein a) the polymer is included in a container with a substantially oxygen-free atmosphere, b) the container is embedded in additional polymer, c) the container embedded in additional polymer is compressed at about 150° C. to about 300° C. and pressures between about 50 bar and about 400 bar and d) the resultant at least one of semi-products, molded products and finished products is separated from the container.

2. The method according to claim 1 wherein the container is formed from a polymer film with barrier properties against oxygen.

3. The method according to claim 2 wherein the container is formed from a polymer with temperature stability up to about 300° C.

4. The method according to claim 1 wherein the inclusion of the polymer is effected by at least one of adhesion and welding of the container.

5. The method according to claim 1 wherein the oxygen-free atmosphere in the container is produced by evacuation.

6. The method according to claim 1 wherein the substantially oxygen-free atmosphere in the container is produced by flushing with an inert gas.

7. The method according to claim 1 wherein the polymer comprises high molecular weight polyethylene (HMW-PE) with a molecular weight of more than about 500,000 g/mol.

8. The method according to claim 1 wherein the polymer comprises ultra-high molecular weight polyethylene (UHMW-PE) with a molecular weight of more than about 2,000,000 g/mol.

9. The method according to claim 1 wherein the sintering process is implemented at a temperature between about 150° C. and about 250° C. and at a pressure between about 80 bar and about 130 bar.

10. The method according to claim 1 wherein the sintering process is effected without addition of further additives.

11. The at least one of semi-products, molded products and finished products made according to the method of claim 1 and having a density between 0.940 and 0.970 cm³/g, preferably between 0.945 and 0.960 cm³/g.

12. The at least one of semi-products, molded products and finished products of claim 11 having no further additives.

13. Use of the at least one of semi-products, molded products and finished products of claim 11 for producing preforms which can be further processed with low mechanical complexity.

14. Use of the at least one of semi-products, molded products and finished products of claim 11 for producing at least one of bio-inert medical appliances and bio-inert medical implants.

15. Use of the at least one of semi-products, molded products and finished products of claim 11 for technical components which exhibit at least one of increased ageing resistance and low abrasion.

16. The method according to claim 2 wherein the inclusion of the polymer is effected by at least one of adhesion and welding of the container.

17. The method according to claim 3 wherein the inclusion of the polymer is effected by at least one of adhesion and welding of the container.

18. The method according to claim 2 wherein the oxygen-free atmosphere in the container is produced by evacuation.

19. The method according to claim 3 wherein the oxygen-free atmosphere in the container is produced by evacuation.

20. The method according to claim 4 wherein the oxygen-free atmosphere in the container is produced by evacuation.
